(19) United States
(12) Patent Application Publication
(10) Pub. No.: US 2026/0236448 A1
(43) Pub. Date: Aug. 13, 2026

(54) Version-Controlled Concurrency Management

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 19/415,384

(22) Filed: Dec. 10, 2025

Related U.S. Application Data
(60) Provisional application No. 63/758,273, filed on Feb. 13, 2025.

(51) Int. Cl. G06F 16/23; G06F 16/27

(52) U.S. Cl. CPC G06F 16/2329; G06F 16/27

(57) ABSTRACT

Techniques for detecting, preventing, and diagnosing concurrency issues are disclosed. The system allocates threads isolated sections of runtime memory, and the system allows the threads to concurrently manipulate separates copies of the same runtime objects in these isolated sections. For any given copy of a runtime object, the system may track the version of the runtime object to which this given copy corresponds. Accordingly, the system may detect divergent mutations to separate copies of a runtime object. In response to certain interactions with a runtime object, the system attempts to synchronize copies of the runtime objects. While attempting to synchronize separate copies of a runtime object, the system may merge compatible mutations to these copies to generate a new version of the runtime object, or the system may flag conflicting mutations to these copies that are symptomatic of a causality bug.

### BENEFIT CLAIMS; RELATED APPLICATIONS; INCORPORATION BY REFERENCE

This application claims the benefit of U.S. Provisional Patent Application 63/758,273, filed Feb. 13, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to concurrent computing architectures. In particular, the present disclosure relates to techniques for avoiding potential concurrency issues.

### BACKGROUND

With respect to a computing architecture, the term “concurrency” refers to the ability of a computing system to perform multiple tasks simultaneously and/or the ability of the computing system to perform multiple tasks in overlapping time periods. The term “task” refers to a set of one or more related computing operations. Performing tasks concurrently can improve the efficiency and performance of a computing system. However, concurrency can also give rise to an issue that results from one task interfering with another task being performed concurrently (referred to herein as a “concurrency issue”). Many varieties of concurrency issues can result from data races. Example concurrency issues that may directly or indirectly result from a data race include nondeterministic behavior, memory corruption, livelock, deadlock, resource starvation, undefined program behavior, difficult to reproduce bugs, security risks, and others.

A concurrency issue can result from conflicting accesses to the same location in memory. For example, a concurrency issue may arise if (a) two or more threads of execution are concurrently performing tasks that involve accessing the same shared data structure and (b) at least one of those tasks is attempting to mutate the shared data structure. As used herein, the term “shared data structure” refers to a data structure accessible to multiple independent processes and/or subcomponents of processes. A runtime object is one of many examples of a data structure that may exist in runtime memory, and a shared object is one of many examples of a shared data structure. The verb “mutate” refers to changing the state of a data structure, and the noun “mutator” refers to a process and/or a subcomponent of that process attempting to mutate a data structure. A thread of execution that writes a new value to a data structure is an example of a mutator. The term “thread of execution” is used herein to identify a subcomponent of a process. For brevity, a thread of execution may be referred to herein simply as a “thread.” Two threads that access a shared data structure in a conflicting manner may be constituents of the same process, or those two threads may be constituents of two different processes.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating a computer system suitable for implementing methods and features described herein in accordance with one or more embodiments;

FIG. 3 illustrates an example virtual machine (VM) memory layout in block diagram form in accordance with one or more embodiments;

FIG. 4 illustrates an example frame in block diagram form in accordance with one or more embodiments;

FIG. 5 illustrates a system for practicing techniques described herein in accordance with one or more embodiments;

FIG. 6 illustrates an example set of operations for managing versions of a data set in accordance with one or more embodiments;

FIGS. 7A, 7B, 7C, and 7D illustrate the impact of an example set of operations for version management in accordance with an example embodiment; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. CONCURRENCY MANAGEMENT SYSTEM
4. VERSION MANAGEMENT
5. EXAMPLE EMBODIMENT
6. PRACTICAL APPLICATIONS AND ADVANTAGES
7. HARDWARE OVERVIEW
8. MISCELLANEOUS; EXTENSIONS

### 1. General Overview

One or more embodiments prevent concurrency issues by triggering modifications in data structures in a shared area of runtime memory based on corresponding data structures in thread-specific isolated sections of runtime memory. For instance, the system may allow individual threads to manipulate separate, isolated copies of the same set of runtime objects. The isolated copies of the set of runtime objects reside in isolated sections of runtime memory that are respectively allocated to the individual threads. An isolated section of runtime memory exposed to one thread is not exposed to the other threads. Therefore, a thread is free to manipulate an isolated copy of the set of runtime objects that resides in the thread's isolated section of runtime memory without risk of interference from another thread's activities. At the same time, a shared copy of the set of runtime objects resides in the shared area of runtime memory. The system may permit a thread to synchronize the thread's isolated copy of the set of runtime objects with the shared copy of the runtime objects. By synchronizing an isolated copy of the set of runtime objects with the shared copy of the set of runtime objects, a thread may (a) commit, to the shared copy, mutations that the thread has already applied to the isolated copy (b) apply, to the isolated copy, mutations that other threads have already committed to the shared copy. The system attempts to synchronize copies of the set of runtime objects in response to certain events that are referred to herein as “synchronization triggers.” For example, the system may direct a thread to initiate a synchronization attempt in response to a program instance instructing the thread to access a direct-write field (i.e., a synchronization trigger). As used herein, the term “direct-write field” refers to a field whose values are generally (a) written directly to main memory and (b) read directly from main memory. During an attempt to synchronize a shared copy of the set of runtime objects with an isolated copy of the set of runtime objects, a thread is directed to compare (a) any mutations that other threads have committed to the shared copy that these two copies were last synchronized with (b) any mutations the thread has applied to the isolated copy since these two copies were last synchronized. Thus, when a thread attempts to synchronize the shared copy of the set of runtime objects with an isolated copy of the set of runtime objects, the thread will determine if there are any mutations that have been committed to the shared copy that conflict with mutations that have been applied to the isolated copy. Accordingly, instead of causing concurrency issues, any shortcomings in a programmer's code will be revealed by merge conflicts that are identified when a thread attempts to synchronize the shared copy of the set of runtime objects with an isolated copy of the set of runtime objects.

One or more embodiments compel threads to indirectly manipulate a version-controlled data set through isolated sections of runtime memory where certain interactions with an isolated copy of the data set residing in an isolated section of runtime memory triggers attempts to synchronize the isolated copy of the data set with a shared copy of the data set that resides in a shared area of runtime memory. For instance, the system may allow threads to create isolated copies of the same set of runtime objects in isolated sections of runtime memory that are respectively allocated to the program threads, and the system allows the threads to optimistically mutate their respective isolated copies. At the same time, a shared copy of the set of runtime objects is maintained in the shared area of runtime memory. For any given copy of the set of runtime objects that resides in an isolated section of runtime memory or the shared area of runtime memory, the system tracks the version of the set of runtime objects that this given copy corresponds to. By independently tracking the respective versions of the multiple copies of the set of runtime objects, the system can discern if separate copies of the set of runtime objects potentially include conflicting mutations. If separate copies of the set of runtime objects potentially include conflicting mutations, the system compares the mutations that have been applied respectively to these separate copies to determine if there are, in fact, any conflicting mutations. If there are conflicting mutations, the system directs the thread to flags these conflicting mutations as symptoms of a causality bug in a program instance that is being executed by the threads. If there are no conflicting mutations, the system permits the thread to synchronize these copies by merging their respective mutations, thereby establishing a new version of the set of runtime objects.

One or more embodiments compel threads to indirectly manipulate shared non-volatile values indirectly through isolated copies of the shared non-volatile values that reside in isolated sections of runtime memory, where certain interactions with shared volatile values trigger attempts to synchronize an isolated copy of the shared non-volatile values residing in an isolated section of runtime memory with the shared non-volatile information that resides in a shared area of runtime memory. As used herein, a “volatile value” refers to information held by a direct-write field, and a “non-volatile value” refers to information that is not held by a direct-write field. For instance, rather than permitting the program instance to directly read from and/or write to non-direct-write fields of a shared copy of a set of runtime objects residing in a shared area of runtime memory, the system may direct threads to create isolated copies of this set of runtime objects in isolated sections of runtime memory. The threads are subsequently permitted to complete requests of the program instance on these isolated copies of the set of runtime objects. After a thread mutates an isolated copy of the set of runtime objects pursuant to a request from the program instance, the system may permit the thread to commit these mutations to the shared copy of the set of runtime objects if another thread has not already committed a conflicting mutation to this shared copy. In this way, mutations to non-volatile values of an isolated copy of the set of runtime objects are effectively buffered until a synchronization trigger initiates an attempt to synchronize this isolated copy of the set of runtime objects with the shared copy of the set of runtime objects. For example, mutations applied to an isolated copy of the set of runtime objects may be buffered until a thread attempts to read from or write to a direct-write field.

One or more embodiments detect and diagnose concurrency issues by tracking a happens-before ordering of versions of a data set that is being concurrently manipulated by multiple threads. For instance, synchronizing copies of a set of runtime objects may create a new version of the set of runtime objects. To record the new version of the set of runtime objects that is established by this synchronization, the system directs a thread generate a special runtime object (referred to herein as a “commit object”) to represent the new version. The system tracks a happens-before ordering of the versions of the set of runtime objects by creating an object graph of commit objects that respectively correspond to the versions. The system creates the object graph of commit objects by interconnecting the commit objects with references. For example, if one version of the set of runtime objects is derived from another version of the set of runtime objects, a commit object representing the one version may include a reference to another commit object representing the other version. Any given commit object that represents a version of the set of runtime objects may record (a) the values that are stored to direct-write fields in that version of the set of runtime objects and/or (b) the mutations that were applied to the set of runtime objects to derive this version of the set of runtime objects from a prior version of the set of runtime objects. Thus, by traversing the object graph, the system can discern the mutations to the set of runtime objects that derived one version of the set of runtime objects from another version of the set of runtime objects. By referencing the object graph in this manner, the system can determine if the mutations to one copy of the set of runtime objects that correspond to one version conflict with the mutations to another copy of the set of runtime objects that corresponds to another version.

One or more embodiments described in this Specification and/or recited in the claims may not be included in this General Overview section.

### 2. Architectural Overview

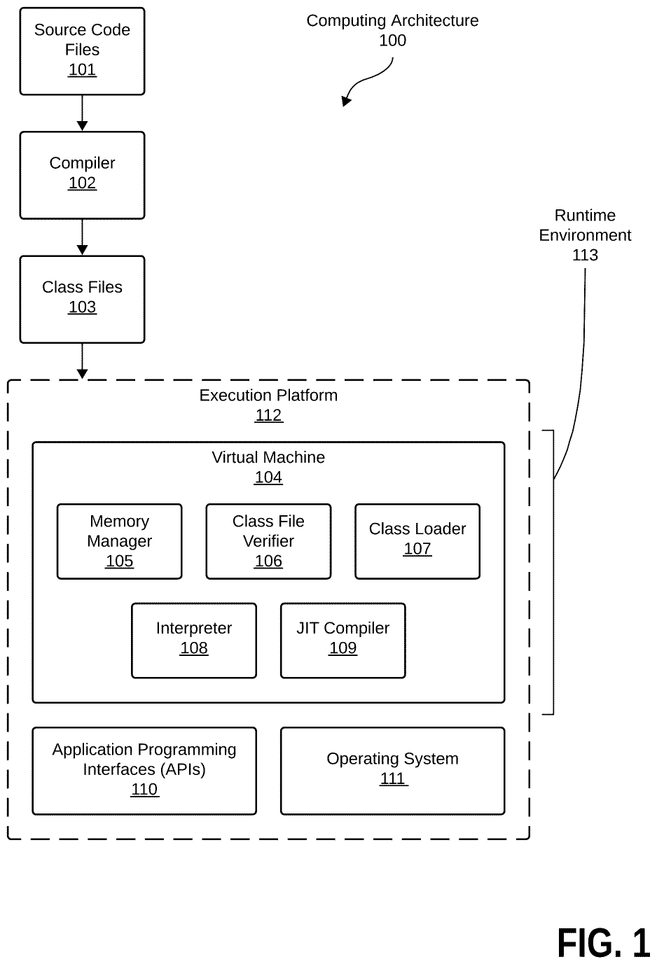

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

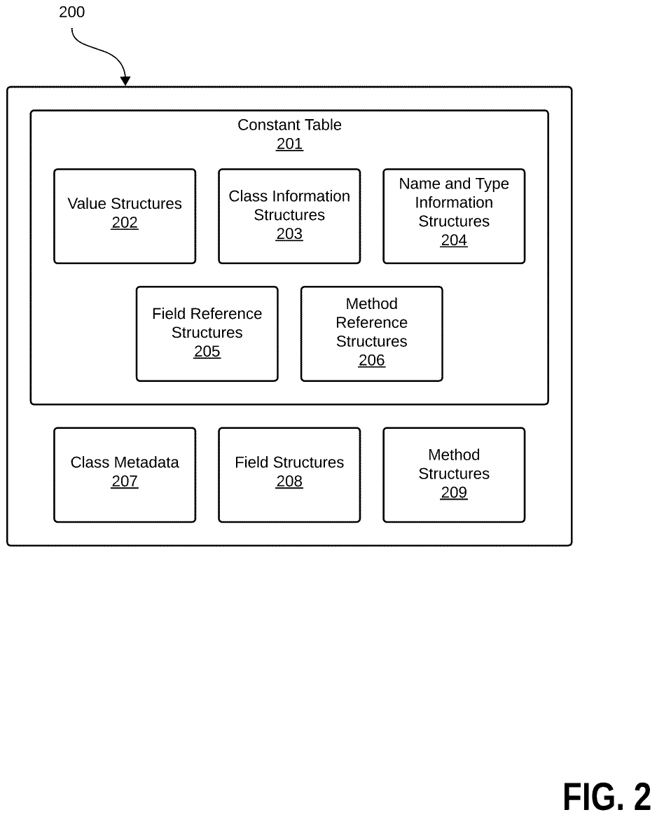

FIG. 2 illustrates an example structure for a class file 200 in block diagram form according to an embodiment. To provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B” byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13( ) {
      return B. addTwo(12, 13);
   }
}

In the above example, the Java method add12and13 is defined in class A, takes no parameters, and returns an integer. The body of method add12and13 calls static method addTwo of class B which takes the constant integer values 12 and 13 as parameters, and returns the result. Thus, in the constant table 201, the compiler 102 includes, among other entries, a method reference structure that corresponds to the call to the method B. addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

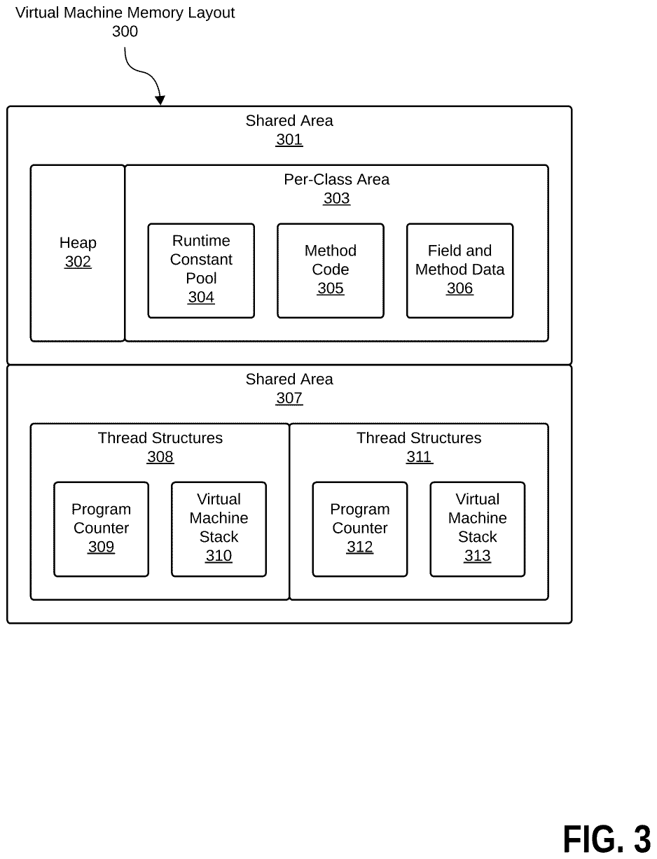

FIG. 3 illustrates an example virtual machine memory layout 300 in block diagram form according to an embodiment. To provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a global area 301 and a thread area 307. The global area 301 represents an area in memory where structures shared among the various threads executing on the virtual machine 104 are stored. The global area 301 includes a heap 302 and a per-class area 303. In an embodiment, the heap 302 represents the run-time data area from which memory for class instances and arrays is allocated. In an embodiment, the per class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

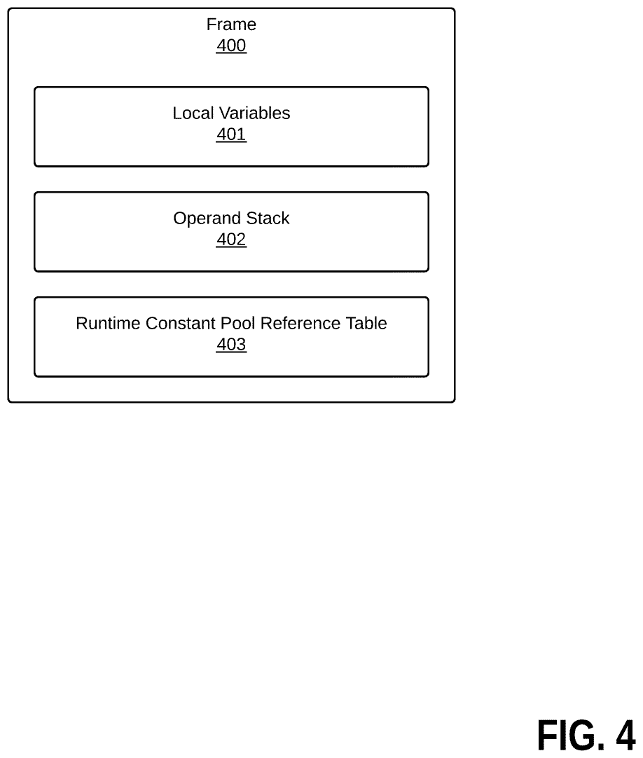

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 includes a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded but does not necessarily require those classes to also be linked before proceeding. For example, assume Class A includes a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. Concurrency Management System

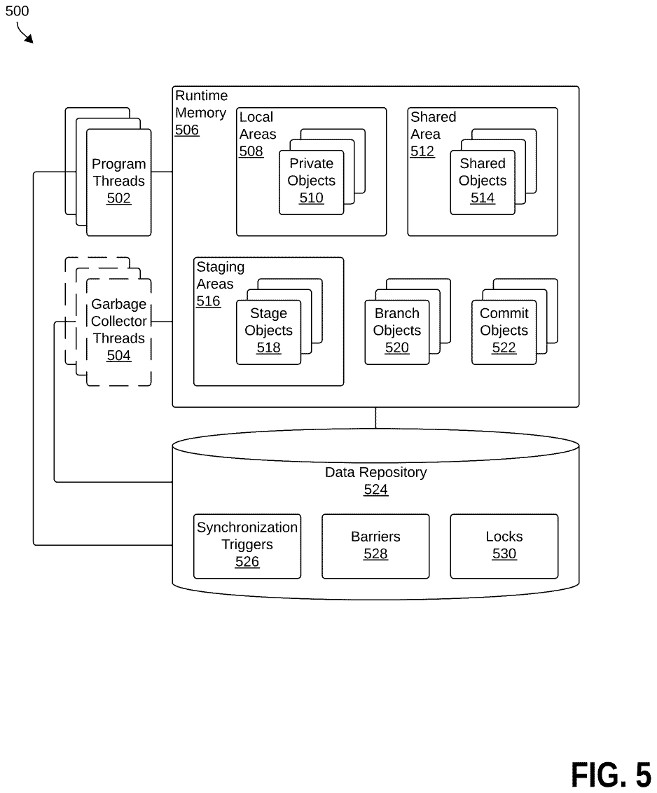

FIG. 5 illustrates a system 500 for practicing techniques described herein in accordance with one or more embodiments. As illustrated in FIG. 5, system 500 may include program threads 502, garbage collector threads 504, runtime memory 506, and data repository 524. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

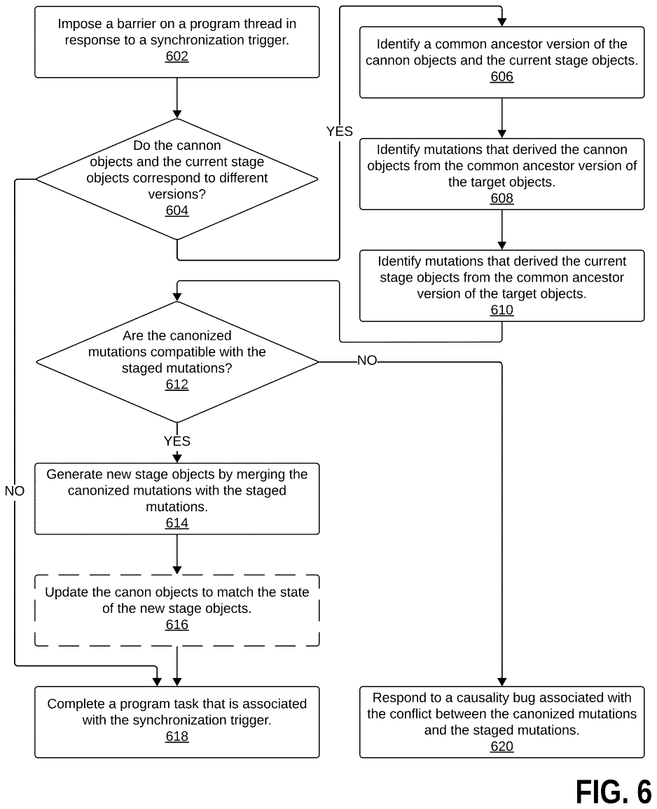

In one or more embodiments, system 500 refers to software and/or hardware configured for managing concurrent computing operations. In this way, system 500 is configured to prevent, detect, and diagnose concurrency issues. A task that is directed to facilitating the prevention, detection, and/or diagnosis of concurrency issues is referred to herein as a “concurrency management task.” Example operations for managing concurrent computing operations are described below with reference to FIG. 6.

In an embodiment, system 500 is implemented in a computing environment that includes multiple threads of executions. As noted above, a thread of execution or thread, such as a program thread 502 or a garbage collector thread 504, is a subcomponent of a process. A thread may serve as an independent execution environment for executable instructions. A multi-thread computing environment is an example of a computing environment that can perform concurrent operations. A typical implementation of the Java Runtime Environment is one example of a multi-thread computing environment. The implementation of system 500 as a threaded computing environment is described herein for illustrative purposes and is not intended to define any limits to this disclosure. A threaded computing environment is neither essential nor necessary to practice the techniques described herein. The techniques described herein are equally applicable to other computing architectures. In general, the techniques described herein are applicable to any computing architecture that can perform concurrent computing operations. The techniques described herein are applicable to both centralized computing systems and distributed computing systems.

In one or more embodiments, a program thread 502 refers to a thread of execution generally allocated to perform tasks at the behest of a program instance. A task that is performed at the behest of a program instance is referred to herein as a “program task.” Note that completing some program tasks may require manipulating information residing in runtime memory 506. For instance, while completing the requests of a program instance, a program thread 502 may be creating new data structures within runtime memory 506, reading from data structures residing in runtime memory 506, writing to data structures residing in runtime memory 506, and/or performing various other operations within runtime memory 506. In addition to program tasks, a program thread 502 may be configured to perform other tasks. For example, a program thread 502 may be configured to perform concurrency management tasks, garbage collection tasks, and/or other tasks. A program thread 502 may be configured to perform tasks other than program tasks through the imposition of barriers 528.

In one or more embodiment, a garbage collector thread 504 refers to a thread of execution generally allocated to perform tasks at the behest of a garbage collection process. As used herein, the term “garbage collection” refers generally to memory management, and the term “garbage collection task” refers to a task performed at the behest of a garbage collection process. In the example context of system 500, a garbage collection process may be configured to reclaim memory allocated to data structures residing within runtime memory 506 that are no longer needed by a currently executing program instance. In some embodiments, system 500 excludes dedicated garbage collector threads 504 because garbage collection tasks are delegated to program threads 502. In other words, in some embodiments, there may be no distinction between a program thread 502 and a garbage collector thread 504. As used herein, the term “garbage collector” refers to any thread performing a garbage collection task. As noted above, both program threads 502 and garbage collector threads 504 may perform garbage collection tasks. Thus, the term “garbage collector” may refer to a program thread 502, a garbage collector thread 504, or another thread.

In one or more embodiments, runtime memory 506 refers to a data repository that includes memory space allocated for the use of at least one program instance during runtime. For example, runtime memory 506 may include data structures, such as shared data structures and private data structures, generated by program threads 502 during program execution. In addition to including information that can be manipulated by a program thread 502 at the behest of a program instance, runtime memory 506 may include information that is not exposed at a program level. For example, runtime memory 506 may include data structures and/or references to data structures that cannot be accessed by a program thread 502 while that program thread 502 is actively executing executable instructions for a program instance. Note that in this example, these data structures that are not exposed at a program level may be accessible to the program thread 502 if and when the program thread 502 is not actively performing program tasks. For instance, in this example, data structures that are generally inaccessible to a program thread 502 while actively performing program tasks may be accessible to the program thread 502 while actively performing concurrency management tasks and/or garbage collection tasks. As illustrated in FIG. 5, runtime memory 506 may be organized into various areas, such as local areas 508, a shared area 512, staging areas 516, and/or other areas. Additionally, or alternatively, runtime memory 506 may be organized into generations and/or other logical or physical subdivisions. For example, runtime memory 506 may be organized into a young generation and an old generation. Runtime memory 506 may be implemented on any type of storage unit and/or device (e.g., a file system, database, collection of tables, or any other storage mechanism) for storing data. Furthermore, runtime memory 506 may be implemented on multiple different storage units and/or devices. The multiple different storage units and/or devices may or may not be of the same type or located at the same physical site. Runtime memory 506 may be implemented in volatile memory, and/or runtime memory 506 may be implemented in persistent memory.

In an embodiment, runtime memory 506 is implemented in the context of one or more class-based, object-oriented programming languages. Examples of class-based, object-oriented programming languages include Java, C++, C#, Python, Ruby, and others. The implementation of runtime memory 506 in the context of class-based, object-oriented program language(s) is described herein for illustrative purposes and is not intended to define any limits to the disclosure. A class-based, object-oriented programming language is neither essential nor necessary to practice the techniques described herein. The techniques described herein are equally applicable to other data structures, other computing environments, and other programming languages.

In an embodiment, information is represented within runtime memory 506 by runtime objects. A runtime object is a data structure that exists in memory during program execution (i.e., runtime). An example runtime object is an instance of a reference type such as a class. A runtime object may be conceptualized as a higher-level abstraction of binary data that resides somewhere in low-level memory. For example, a runtime object may be an abstraction of binary data stored to main memory (e.g., random access memory (RAM)) or a cache (e.g., a thread-local cache). In the example that is illustrated by FIG. 3, runtime memory 506 may be implemented, in whole or in part, within heap 302. As illustrated in FIG. 5, runtime memory 506 may include private objects 510, shared objects 514, stage objects 518, branch objects 520, commit objects 522, and/or other runtime objects.

In an embodiment, a runtime object, such as a private object 510, a shared object 514, or a stage object 518, includes direct-write field(s) and/or non-direct-write field(s). As noted above, the term “direct-write field” refers to a field whose value is generally (a) written directly to main memory and (b) read directly from main memory. For example, if a value is written to a direct-write field, a thread will generally not be permitted to delay storing that value in main memory in favor of performing some other program task. In comparison, if a value is written to a non-direct-write field, a thread may delay storing that value in main memory, and that value may reside in a cache, such as a thread-local cache, while storage of this value to main memory is being delayed. While a value stored to a direct-write field is generally not permitted to languish in a cache while storage to main memory is postponed, note that a value that is written to a direct-write field may temporarily reside in a cache during the process of storing that value to main memory. For example, a value written to a direct-write field may be temporarily stored in a cache to preserve visibility guarantees while that value is being stored to main memory. In general, the implementation of direct-write fields may vary between embodiments. For example, with respect to Java, a direct-write field may be implemented using the “volatile” keyword; in contrast, with respect to C or C++, a direct-write field may be implemented using the “std::atomic” tokens.

In an embodiment, runtime memory 506 is subject to at least one garbage collection process during runtime. For example, during runtime, a garbage collection process may be configured to reclaim memory space allocated to runtime objects residing in runtime memory 506. In this example, the garbage collection process may classify memory space allocated to a runtime object as being eligible for reclamation if that runtime object has become less than strongly reachable. A runtime object is generally considered strongly reachable if there is at least one chain of strong reference(s) that can be traversed by at least one program thread 502 to access that runtime object at the behest of a program instance. The term “strong reference” refers to a reference that (a) fully participates in a reachability analysis performed by a garbage collector and (b) is not subjected to the collection rules that are applied to specialized references, such as soft references, weak references, phantom references, and so on. If there is no chain of strong reference(s) that can be traversed by a program thread 502 to access a runtime object at the behest of a program instance, that runtime object will generally not be considered strongly reachable. Note that a runtime object being less than strongly reachable to a program thread 502 does not necessarily imply that the runtime object is unreachable to that program thread 502. For example, a runtime object that is not strongly reachable may remain reachable through a non-strong reference. Furthermore, the term “unreachable” is not necessarily synonymous with the term “inaccessible.” For example, a runtime object that is unreachable to a program thread 502 may remain accessible to a garbage collector thread 504. As used herein, the term “disposable” identifies information eligible for garbage collection, and the term “live” identifies information ineligible for garbage collection. While strongly reachable objects are generally live objects, note that the term “live” is not interchangeable with “strongly reachable.” For example, runtime objects that are less than strongly reachable, such as softly reachable objects, may be live objects in at least some cases. In other embodiments, runtime memory 506 is not subjected to a separate garbage collection process during runtime. For example, in these other embodiments, disposable information may be deallocated by threads while executing the executable instructions of a program instance.

In one or more embodiments, a local area 508 refers to a section of runtime memory 506 that is generally allocated for the private data structures of a specific program thread 502. For example, a local area 508 of a program thread 502 may include information inaccessible to other program threads 502 while those program threads 502 are actively performing program tasks. A corresponding local area 508 may exist for any given program thread 502. As illustrated in FIG. 5, a local area 508 may include private objects 510 and/or other data structures.

In one or more embodiments, a private object 510 refers to a runtime object that (a) a program instance can interact with through a single program thread 502 and (b) is not a stage object 518. If a runtime object is a private object 510, there is a single program thread 502 that can access that runtime object at the behest of a program instance; no other program thread 502 can obtain a traversable reference to that runtime object while performing a program task. As noted above, some forms of “reachability” do not coincide with accessibility. Thus, a runtime object that is reachable to multiple program threads 502 may nonetheless be a private object 510. Note that the use of the word “private” as an adjective in the term “private object” does not refer to a private accessor flag. A private object 510 does not necessarily include a private field. In many cases, a private object 510 includes no private fields. Generally, a runtime object is initially a private object 510 when that runtime object is instantiated; after being instantiated, a private object 510 may become a shared object 514.

In one or more embodiments, shared area 512 refers to a section of runtime memory 506 that is generally allocated for storing information accessible to multiple program threads 502. In other words, shared area 512 is generally used for storing information exposed to multiple program threads 502. As illustrated in FIG. 5, shared area 512 may include shared objects 514 and/or other data structures.

In one or more embodiments, a shared object 514 refers to a runtime object that a program instance can interact with through multiple program threads 502. Generally, a program instance is able to interact with a runtime object through a program thread 502 if there is at least one chain of references leading to the runtime object that can be traversed by the program thread 502 while executing the program instance. Note that some references, such as phantom references, cannot be traversed by a program thread 502 while executing a program instance. As noted above, multiple conflicting accesses to a shared object 514 may give rise to a concurrency issue. For example, two accesses to a shared object 514 conflict if (a) those two accesses are performed in furtherance of two separate tasks being performed concurrently and (b) at least one of those tasks is attempting to mutate the shared object 514. If the two conflicting accesses are allowed to occur in this example, a data race may occur. However, note that conflicting accesses do not necessarily result in a data race or another concurrency issue. It should also be noted that, in some cases, two accesses to a shared object 514 may conflict even if both of those two accesses are reading from the shared object 514 and not mutating the shared object 514.

In one or more embodiments, a staging area 516 refers to a section of runtime memory 506 allocated for manipulating version-controlled information. For example, a staging area 516 may be reserved for copies of private objects 510 and/or shared objects 514 that a program thread is attempting to manipulate while performing a program task. In this example, the program thread 502 may use this staging area 516 as an isolated environment where the program thread 502 can manipulate these copies of these runtime objects without risk of other threads interfering with the program thread's attempt to complete the program task by concurrently manipulating these copies of these runtime objects.

In an embodiment, a staging area 516 is exposed to a subset of the program threads 502 that share access to runtime memory 506. In an example, a staging area 516 is exposed to a single program thread 502, and other program threads 502 are unable to access information residing in this staging area 516 while performing program tasks. In other words, this staging area 516 is isolated from the other program threads 502 in this example.

In an embodiment, a staging area 516 is configured to serve as an isolated section of runtime memory 506 where a program thread 502 is permitted to access shared, non-volatile information. For example, within a staging area 516, a program thread 502 may be permitted to read from and/or write to non-direct-write fields of runtime objects that are instantiated in the staging area 516. In this embodiment, a program thread 502 may be prevented from directly accessing shared, non-volatile information that resides outside of a staging area 516.

In an embodiment, multiple staging areas 516 are allocated for a single program thread 502. The multiple staging areas 516 may correspond to a different versions of a set of runtime objects. A staging area 516, including the version of a set of runtime objects that a program thread 502 is currently manipulating while performing program tasks, is referred to herein as being the program thread's 502 “current staging area” where the program thread 502 is “based.”

In one or more embodiments, a stage object 518 refers to a runtime object that resides in a staging area 516. A stage object 518 may be a copy of another runtime object that resides elsewhere in runtime memory 506, and/or other runtime objects residing elsewhere in runtime memory 506 may be copies of the stage object 518. A stage object 518 may be a copy of a private object 510, a shared object 514, or another runtime object. Note that the state of a staged copy of a runtime object (i.e., a stage object 518) may diverge from the state of another copy of the runtime object. For example, the state of a stage object 518 may diverge from the state of a corresponding shared object 514 while a program task is being completed in a staging area 516 that includes the stage object 518. It should also be noted that a staged copy of a runtime object may not be identical to another copy of the runtime object when the staged copy of the runtime object is initially created. For example, a direct-write field in a stage object 518 may be configured differently than the same direct-write field in a corresponding shared object 514.

In one or more embodiments, a branch object 520 refers to a runtime object used to track the current version of a data set. For instance, a branch object 520 may track the current version of a set of runtime object(s). As an example, consider a stage object 518 that includes a direct-write field. In this example, the direct-write field in the stage object 518 includes a reference to a branch object 520 used to track the current version of a shared object 514 that corresponds to the stage object 518. The branch object 520 of this example includes a current commit field, and the current commit field holds another reference to a commit object 522 that represents the current version of the shared object 514. In this example, a thread may discern the current version of the shared object 514 by traversing (a) the reference from the stage object 518 to the branch object 520 and (b) the other reference from the branch object 520 to the commit object 522. There may be multiple stage objects 518 corresponding to the shared object 514 in this example, and the multiple stage objects 518 may refer to the same branch object 520.

In one or more embodiments, a commit object 522 refers to a runtime object that represents a version of a data set. For instance, a commit object 522 may represent a version of a set of runtime object(s). An example commit object 522 may record an identifier of a version of a set of runtime objects represented by the commit object 522, values held by direct-write fields in this version of the set of runtime objects, mutations that derived this version of the set of runtime objects from a prior version of the set of runtime objects, and/or other information. Furthermore, the example commit object 522 may refer to other commit objects 522. For instance, the example commit object 522 may include a field that refers to another commit object 522 that represents the prior version of the set of runtime objects.

In an embodiment, an object graph of commit objects 522 is configured to track a version history of a data set. For instance, an object graph of commit objects 522 may track a version history of a program thread's stage objects 518 and/or a version history of the corresponding private objects 510 and/or shared objects 514. The commit objects 522 included in an object graph are linked by references between the commit objects 522. As an example, consider one commit object 522 that represents one version of a set of runtime objects and another commit object 522 that represents another version of the set of runtime objects. For the purposes of this example, assume that the one version of the set of runtime objects is derived directly from the other version of the set of runtime objects. To record this relationship, a field in the one commit object 522 refers to the other commit object 522 in this example. Note that in this example, the reference from the one commit object 522 to the other commit object 522 may reflect both temporal sequence and causality. By linking commit objects 522 with chains of references in this way, an object graph of commit objects 522 may record a happens-before ordering of versions.

In one or more embodiments, a data repository 524 is any type of storage unit and/or device (e.g., a file system, database, collection of tables, or any other storage mechanism) for storing data. Furthermore, a data repository 524 may include multiple different storage units and/or devices. The multiple different storage units and/or devices may or may not be of the same type or located at the same physical site. Furthermore, a data repository 524 may be implemented or executed on the same computing system as other components of system 500. Additionally, or alternatively, a data repository 524 may be implemented or executed on a computing system separate from other components of system 500. The data repository 524 may be communicatively coupled to other components of system 500 via a direct connection or via a network. As illustrated by FIG. 5, data repository 524 may include information describing synchronization triggers 526, barriers 528, locks 530, and/or other information.

In one or more embodiments, a synchronization trigger 526 refers to an event that may trigger an attempt to synchronize copies of a data set. For example, a synchronization trigger 526 may be some event that causes an attempt to synchronize a set of shared objects 514 with a program thread's 502 corresponding set of stage objects 518. In general, the events that are configured as synchronization triggers 526 may vary between embodiments. Example events that may be synchronization triggers include an attempt to access a direct-write field, an attempt to access a final field, a program task that is defined using a synchronized keyword, a program task that is defined using an atomic keyword, a program task that involves accessing a memory location through a var handle, a joining of threads, a termination of a thread, a garbage collection task that requires synchronization of runtime memory, and others.

In an embodiment, a synchronization trigger 526 is an attempt to access a direct-write field. For example, the system may direct a program thread 502 to attempt to synchronize a set of shared objects 514 with the program thread's 502 corresponding set of stage objects 518 in response to a program instance instructing the program thread 502 to read from and/or write to a direct-write field in one of these runtime objects.

In an embodiment, a synchronization trigger 526 is a program task defined in source code using a special token. For example, the system may direct a program thread 502 to attempt to synchronize a set of shared objects 514 with the program thread's 502 corresponding stage objects 518 in response to a program task defined in source code using a synchronized keyword, an atomic keyword, or another token designated as a synchronization trigger. In general, the tokens that are configured to trigger synchronization attempts may vary between embodiments.

In one or more embodiment, a barrier 528 refers to an additional set of executable instructions inserted into or proximate to executable instructions that a thread is generally allocated to executed. For example, while converting class files 103 of a program into machine-level code, JIT compiler 109 may insert barriers 528 into the machine-level instructions that correspond to the program tasks to be performed by a program thread 502. A barrier 528 is referred to herein as being “imposed” on a thread when the thread is actively performing the executable instructions defined in the barrier 528. Barriers 528 may be imposed on program threads 502, and/or barriers 528 may be imposed on garbage collector threads 504. By imposing a barrier 528 on a program thread 502 that is completing requests of a program instance (i.e., program tasks), system 500 may compel that program thread 502 to perform operations other than the operations requested by the program instance. Example barriers 528 that may be imposed on a thread include load barriers, store barriers, and others.

In an embodiment, a barrier 528 is a load barrier. As used herein, the term “load barrier” refers to a barrier 528 imposed on a thread in response to the thread being instructed to perform a load operation. An example load operation is a request by a program instance for a program thread 502 to load a reference to a runtime object. An example load barrier defines operations that a program thread 502 should perform before and/or after a load operation that triggers the imposition of the example load barrier.

In an embodiment, a barrier 528 is a store barrier. As used herein, the term “store barrier” refers to a barrier 528 imposed on a thread in response to the thread being instructed to perform a store operation. An example store operation is a request by a program instance for a program thread 502 to write a value to a location in memory such as an object field of a runtime object. An example store barrier defines operations that a program thread 502 should be required to perform before and/or after a store operation.

In an embodiment, a barrier 528 includes executable instructions for performing a concurrency check. As noted above, a concurrency check is a check for potential concurrency issues. Example mechanisms that may be leveraged by a barrier 528 to perform a concurrency check include an object graph of commit objects 522, event tracing, execution tracing, Lamport timestamps, vector clocks, hybrid logical clocks, timestamps, read/write counters, locks 530, data-flow analysis, and others.

In an embodiment, a barrier 528 includes executable instructions for detecting conflicting mutations to separate copies of a data set (i.e., a concurrency check). For example, a barrier 528 may direct a program thread to check if there are any mutations to stage objects 518 that conflict with mutations to the corresponding shared objects 514.

In an embodiment, a barrier 528 includes executable instructions for synchronizing copies of a data set. For example, a barrier 528 may direct a program thread 502 to attempt to synchronize stage objects 518 with the corresponding shared objects 514.

In an embodiment, a barrier 528 includes executable instructions for acquiring a lock 530 on a memory location. For example, a barrier 528 may direct a program thread 502 to acquire a lock on a shared object 514 before attempting to synchronize the shared object 514 with a corresponding stage object 518.

In an embodiment, a barrier 528 includes executable instructions for establishing a new version of a data set. For example, when a shared copy of a set of runtime objects (i.e., shared objects 514) is synchronized with a staged copy of the set of runtime objects (i.e., staged objects 518), a barrier 528 may direct a program thread 502 to establish a new version of the set of runtime objects that results from this synchronization. In this example, the barrier 528 directs the program thread 502 to establish the new version of the set of runtime objects by creating a new commit object 522 to represent the new version.

In an embodiment, a barrier 528 includes executable instructions for rebasing a thread to a new staging area 516. As used herein, the term “rebasing” refers to creating a new staging area 516 for a thread. When a thread is rebased to a new staging area 516, that new staging area 516 becomes the thread's current staging area. For example, when a new version of a set of runtime objects is created by synchronizing a shared copy of the set of runtime objects with a staged copy of the set of runtime objects, a barrier 528 may direct a program thread 502 to create a new copy of the set of runtime objects that corresponds to the new version. In this example, the new copy of the set of runtime objects may incorporate both (a) any mutations made to the shared copy of the set of runtime objects since the shared copy was last synchronized with the staged copy and (b) any mutations made to the staged copy of the set of runtime objects since the shared copy was last synchronized with the staged copy. In this example, the barrier 528 directs the program thread 502 to create this new staged copy of the set of runtime objects in a new staging area 516 allocated for the program thread 502.

In an embodiment, a barrier 528 includes executable instructions for selectively blocking a thread from performing certain operations. For example, if a concurrency check indicates a program task is causally inconsistent with some other task, a barrier 528 may direct a thread to abort, postpone, and/or restart the program task. A barrier 528 may block a thread from performing a subset of a task, and/or a barrier 528 may block a thread from performing the entirety of a task. In some cases, a barrier 528 may include executable instructions for conditionally terminating a program instance.

In an embodiment, a barrier 528 includes executable instructions for performing operations that facilitate a garbage collection process in runtime memory 506 (referred to herein as “garbage collection operations”). In this way, a barrier 528 may be utilized to temporarily commandeer a program thread 502 for garbage collection operations. A barrier 528 may direct a thread to perform garbage collection operations directed to private objects 510, shared objects 514, stage objects 518, branch objects 520, commit objects 522, and/or other data structures.

In an embodiment, a barrier 528 includes executable instructions for coloring pointers. As used herein, the phrase “coloring a pointer” refers to embedding metadata into bit(s) within the pointer that are not being used for storing an address of a location in memory. A pointer is a cluster of bits in low-level memory. Note that a reference, such as a reference to a runtime object, may be implemented in low-level memory using a pointer. A barrier 528 may direct a thread to color a pointer to record the state of a memory location referenced by the pointer, the state of a memory location where the pointer resides, the state of the pointer, and/or other information. For example, a barrier 528 may direct a thread to color pointers to track the stage objects 518 that have been rebased from an old staging area 516 to a new staging area.

In one or more embodiments, a lock 530 refers to a mechanism for controlling access to a memory location. For example, a lock 530 may be used to restrict access to a shared object 514. If a thread holds a lock 530 on a shared object 514, other threads may be prevented from manipulating that shared object 514 if the thread retains the lock 530 on the shared object 514. Example locks 530 that may be utilized by system 500 to restrict access to shared objects 514 include mutex locks, read-write locks, spinlocks, re-entrant locks, semaphore locks, and others.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Concurrency Management

FIG. 6 illustrates an example set of operations for managing versions of a data set in accordance with one or more embodiments. One or more operations illustrated in FIG. 6 may be modified, rearranged, or omitted. Accordingly, the sequence of operations illustrated in FIG. 6 should not be construed as limiting the scope of one or more embodiments. In some embodiments, the operations illustrated in FIG. 6 are performed in a multi-threaded computing environment that is executing a program instance specified in at least one object-oriented programming language. To provide a cohesive explanation and clear examples, the remainder of this section will assume the same. However, neither a threaded computing environment nor an object-oriented programming language are essential or necessary to practice the techniques described herein. The techniques described herein are equally applicable to other concurrent computing environments and other programming languages.

In one or more embodiments, the system imposes a barrier on a program thread in response to a synchronization trigger (Operation 602). As noted above, a synchronization trigger refers to an event that may trigger an attempt to synchronize copies of a data set, and a barrier is an additional set of executable instructions inserted into or proximate to executable instructions that a thread is generally allocated to execute. Here, the synchronization trigger may initiate an attempt to synchronize any changes that have been made to separate copies of a set of runtime object(s) (referred to hereafter as “the target objects”), and the barrier includes executable instructions for attempting said synchronization as needed and/or responding to any conflicting mutations to the copies of the target objects that may be revealed during the synchronization attempt. At present, one copy of the target objects resides in a shared area of runtime memory and/or the program thread's local area of runtime memory; in other words, this copy of the target objects may include shared objects and/or private objects. Hereafter, the copy of the target objects that resides in the shared area and/or the program thread's local area is referred to as “the cannon objects.” Another copy of the target objects resides in a staging area of runtime memory where the program thread is currently based. Hereafter, the staging area where the program thread is currently based is referred to as “the current staging area,” and the copy of the target objects that resides in the current staging area is referred to as “the current stage objects.” Note that the program thread may have been previously based in other staging areas within runtime memory, and there may have been other copies of the target objects that were created in these other staging areas before the current stage objects were created in the current staging area. Furthermore, other threads may possess other copies of target objects in other staging areas. Previously, the cannon objects and the current stage objects both corresponded to the same version of the target objects. For example, the cannon objects and the current stage objects were the same version of the target objects when the cannon objects were last synchronized with the current stage objects (referred to hereafter as “the last synchronization”). At present, the cannon objects and the current stage objects may correspond to different versions of the target objects. For example, in the time that has elapsed since the last synchronization, another thread may have mutated the cannon objects by committing staged changes to the shared area of runtime memory. Alternatively, the cannon objects and the current stage objects may remain the same version of the target objects. For example, the cannon objects and the current stage objects may remain the same version of the target objects if the cannon objects have not been mutated by another thread since the last synchronization. Note that a mutation to a stage object does not necessarily establish a new version of the target objects.

In an embodiment, a program instance is instructing the program thread to complete a task (referred to hereafter as “the program task”), and the system imposes the barrier on the program thread because completing the program task is associated with the synchronization trigger; to provide a cohesive explanation, the remainder of this section will assume the same. In general, the requests by a program instance that merit a synchronization attempt may vary depending on the implementation of the system and the circumstances of the requests. In an example, completing the program task entails reading from and/or writing to a direct-write field of a version-controlled target object. In this example, the program instance's request to read from and/or write to this direct-write field while completing the program task is the synchronization trigger, and the system inserts the barrier into or proximate to the executable instructions for reading from and/or writing to this direct-write field. In another example, the program task entails reading from and/or writing to a final field of a target object (i.e., the synchronization trigger). In yet another example, the program task is defined in source code with a synchronized keyword, an atomic keyword, or some other special keyword or other token designated as a synchronization trigger. In yet another example, the source code of the program task directs the program thread to access some location in memory using a var handle or some other access mechanism that may be associated with memory ordering semantics. In other embodiments, the synchronization trigger is not explicitly defined in the executable instructions of a program instance. For example, the synchronization trigger may be a termination of a thread, a joining of threads, an attempt by a garbage collection process to synchronize threads during a garbage collection cycle, or some other event not necessarily explicitly represented within the executable instructions of a program instance.

In one or more embodiments, the program thread, acting pursuant to the barrier, determines if the cannon objects and the current stage objects are different versions of the target objects, and the program thread proceeds to another operation based on this determination (Operation 604). To determine if the cannon objects and the current stage objects are different versions of the target objects, the program thread identifies the version of the target objects that the cannon objects presently correspond to (referred to hereafter as “the present version of the cannon objects”), and the program thread identifies the version of the target objects that the current stage objects presently correspond to (referred to hereafter as “the present version of the current stage objects”). If the present version of the cannon objects is different than the present version of the current stage objects, then program thread proceeds to Operation 606. In this scenario, the program thread will attempt to create a new version of the target objects by merging (a) any changes that have been made to the cannon objects since the last synchronization with (b) any changes that have been made to the current stage objects since the last synchronization. Alternatively, if the present version of the cannon objects coincides with the present version of the current stage objects, then the program threads proceed to Operation 618. In this alternative scenario, the system can generally assume that the state of the cannon objects remains unchanged since the last synchronization, and the program thread may be permitted to proceed with completing the program task.

In an embodiment, the present version of the cannon objects is recorded by a commit object, and the program thread identifies the present version of the cannon objects by locating this commit object. Hereafter, the commit object that records the present version of the cannon objects is referred to as “the commit object for the cannon objects.” As an example, assume that the executable instructions for completing the program task instruct the program thread to read from and/or write to a particular direct-write field of a version-controlled cannon object (i.e., the synchronization trigger). Rather than allowing the program thread to directly manipulate the cannon objects in this example, the program thread will instead be compelled to access this particular direct-write field through the corresponding stage object that resides in the current staging area, a branch object, and the commit object for the cannon objects. In the corresponding stage object, this particular direct-write field holds a reference to the branch object, and an object field of the branch object holds another reference to the commit object for the cannon objects. Before the program thread is permitted to read from and/or write to the particular direct-write field, the program thread traverses this chain of references leading to the commit object for the cannon objects. By traversing this chain of references, the program thread locates the commit object for the cannon objects in this example, and the program thread inspects the commit object for the cannon objects to ascertain the present version of the cannon objects. In another example, a reference held by a global storage mechanism is used to track the commit object corresponding to the most recent version of the cannon objects, and the program thread traverses this reference to locate the commit object for the cannon objects, thereby ascertaining the present version of the cannon objects.

In an embodiment, the present version of the current stage objects is recorded by a commit object, and the program thread identifies the present version of the current stage objects by locating this commit object. Hereafter, the commit object that represents the present version of the current stage objects is referred to as “the commit object for the current stage objects.” In an example, the program thread maintains a reference used to track the most recent version of the current stage objects; at present, this reference points to the commit object for the current stage objects. In this example, the program thread maintains this reference in runtime memory, or the program thread maintains this reference in some other memory location readily accessible to the program thread, such as a local variable or a thread-local variable. In this example, the program thread traverses this reference to locate the commit object for the current stage objects, thereby identifying the present version of the current stage objects.

In one or more embodiments, the program thread, acting pursuant to the barrier, identifies a version of the target objects that the original objects and the current stage objects are both derived from (Operation 606). Hereafter, this version of the target objects identified by the program thread is referred to as “the common ancestor version.” The common ancestor version is the present version of the original objects, or the common ancestor version is another version of the target objects that predates the present version of the original objects in a version history of the original objects. Furthermore, the common ancestor version may be the present version of the current stage objects, or the common ancestor version may be another version of the target objects that predates the present version of the current stage objects in a version history of the program thread's stage objects. The program thread may identify the common ancestor version by cross referencing the version history of the cannon objects against the version history of the program thread's stage objects. In an example, the program thread iterates through these version histories until identifying the most recent version of the target objects that the cannon objects and the current stage objects are both derived from.

In an embodiment, the program thread identifies the common ancestor version based on at least one object graph of commit objects. In this embodiment, the version history of the cannon objects is tracked using an object graph of commit objects, and the version history of the program thread's stage objects is tracked using the same object graph of commit objects or a separate object graph of commit objects. The commit objects included in an object graph are linked by references between the commit objects that reflect a happens-before ordering of versions of the target objects. In this embodiment, the program thread may identify the common ancestor version by traversing these references between commit objects. As an example, assume that neither the present version of the cannon objects nor the present version of the current stage objects is the common ancestor version. In this example, the program thread may traverse references between commit objects until identifying a particular commit object that is both (a) linked to the commit object for the cannon objects by a chain of at least one reference originating from commit object for the cannon objects and (b) linked to the commit object for the current stage objects by another chain of at least one reference originating from the commit object for the current stage objects. In this example, the program thread identifies the particular version of the target objects represented by the particular commit object as the common ancestor version because these two chains of references indicate that both the present version of the cannon objects and the present version of the stage objects are derived from this particular version of the target objects.

In one or more embodiments, the program thread, acting pursuant to the barrier, identifies any mutations to the cannon objects that derived the cannon objects from the common ancestor version of the target objects (Operation 608). If the present version of the cannon objects is the common ancestor version, there may be no mutations identified by the program thread in this operation. Hereafter, any mutations that derived the cannon objects from the common ancestor version of the target objects are referred to as “the canonized mutations.” The program thread may identify the canonized mutations based on the version history of the cannon objects.

In an embodiment, the program thread identifies the canonized mutations based on an object graph of commit objects. As an example, assume that a chain of references between commit objects links the commit object for the cannon objects to a commit object representing the common ancestor version. In this example, any given commit object intersected by this chain of references records the mutations that derived (a) the version of the target objects represented by the given commit object from (b) the version of the target objects represented by the commit object that immediately precedes the given commit object in the chain of references. To determine the canonized mutations in this example, the program thread walks this chain of references and compiles the mutations recorded by the individual commit objects intersected by this chain.

In one or more embodiments, the program thread, acting pursuant to the barrier, identifies any mutations that derived the current stage objects from the common ancestor version of the target objects (Operation 610). Hereafter, any mutations that derived the current stage objects from the common ancestor version of the target objects are referred to as “the staged mutations.” The program thread may identify the staged mutations based on the version history of the program thread's stage objects.

In an embodiment, the program thread identifies the staged mutations based on an object graph of commit objects. As an example, assume a chain of references between commit objects links the commit object for the current stage objects to a commit object representing the common ancestor version. In this example, any given commit object intersected by this chain of references records the mutations that derived (a) the version of the target objects represented by the given commit object from (b) the version of the target objects represented by the commit object that immediately precedes the given commit object in the chain of references. To determine the staged mutations in this example, the program thread walks this chain of references and compiles the mutations recorded by the individual commit objects intersected by this chain.

In one or more embodiments, the program thread, acting pursuant to the barrier, determines if the canonized mutations are compatible with the staged mutations, and the program thread proceeds to another operation based on this determination (Operation 612). Stated differently, the program thread determines if the canonized mutations conflict with the staged mutations. If the program thread concludes the canonized mutations are compatible with the staged mutations, then the program thread proceeds to Operation 614. In this scenario, the program thread will create a new version of the target objects by synchronizing the canonized mutations with the staged mutations. Alternatively, if the program thread concludes that the canonized mutations are not compatible with the staged mutations, then the program thread proceeds to Operation 620. In this scenario, there is a causality bug in the program instance that is causing the conflict, and the program thread will perform some corrective action to address the causality bug.

In an embodiment, the program thread determines if the canonized mutations are compatible with the staged mutations by comparing (a) the fields updated by the canonized mutations with (b) the fields updated by the staged mutations. If the fields updated by the canonized mutations do not overlap with the fields updated by the staged mutations, then the program thread may conclude that the canonized mutations are compatible with the staged mutations. On the other hand, if the canonized mutations and the staged mutations update the same field of a target object, then the program thread may conclude that the canonized mutations are not compatible with the staged mutations.

In one or more embodiments, the program thread, acting pursuant to the barrier, generates a new copy of the target objects in a staging area of the program thread (Operation 614). Hereafter, the new copy of the target objects is referred to as “the new stage objects.” The program thread creates the new stage objects by merging the canonized mutations with the staged mutations. The program thread may create the new stage objects by iterating through the non-direct-write fields that will be included in the new stage objects and selecting the appropriate copy of the target objects from which the values for these fields should be pulled. For example, if a field of a cannon object was updated by the canonized mutations, the program thread may pull the value held by this cannon copy of the field for inclusion in the corresponding field of the corresponding new stage object. If a field of a current stage object was updated by the staged mutations in this example, the program thread may select the value held by the current stage copy of this field for inclusion in the corresponding field of the corresponding new stage object. If a field of a target object was updated by neither the canonized mutations nor the staged mutations in this example, the program thread may select, for inclusion in the corresponding field of the corresponding new stage object, the value held by the shared ancestor copy of this field, the cannon copy of this field, and/or the current stage copy of this field. The creation of the new stage objects coincides with the establishment of a new version of the target objects, and the program thread may update a version history of the program thread's stage objects accordingly.

In an embodiment, a new staging area is allocated for the program thread, and the program thread creates the new stage objects in the new staging area. In other words, the program threads rebase from the current staging area to the new staging area in this embodiment. In an alternative embodiment, a new staging area is not created for the program thread, and the program thread creates the new stage objects by updating the current stage objects that reside in the program thread's current staging area. In other words, the program thread is not rebased to a new staging area in this alternative embodiment.

In an embodiment, the program thread establishes the new version of the target objects that corresponds to the new stage objects by generating a new commit object to represent the new version of the target objects. In addition to creating the new commit object, the program thread may add the new commit object to an object graph of commit objects that tracks the version history of the program thread's stage objects, and/or the program thread may update other mechanisms used to locate the commit object corresponding to the most recent version of the current stage objects. For example, to add the new commit object to an object graph of commit objects, the program thread may store a reference in the new commit object that points to the commit object for the current stage objects. Furthermore, in this example, the program thread may maintain a reference used to track the commit object that corresponds to the most recent version of the program thread's stage objects, and the program thread may remap this reference from the commit object for the current stage objects to the new commit object.

In an embodiment, the program thread stores references to branch objects in any direct-write fields of the new stage objects. For example, while creating a new stage object that includes a direct-write field, the program thread may store a reference in this direct-write field that points to a branch object. In this example, the branch object refers to the commit object for the present version of the cannon objects, and this branch object is the same branch object referenced by the corresponding direct-write field in the corresponding current stage object. In another example, the program thread may create a new branch object while creating the new stage object. If the program thread will be updating the cannon objects to match the state of the new stage objects in this other example, the new branch object may refer to the new commit object when the new branch object is created by the program thread.

In an embodiment, a new staging area is allocated for the program thread, and the program thread lazily creates new stage objects in the new staging area as these new stage objects become needed for completing requests from the program instance. For example, in this embodiment, other barriers that are subsequently imposed on the program thread while the program thread is completing the program task may direct the program thread to create new stage objects if and when these new stage objects are needed to complete the program task. By lazily creating new stage objects if and when the new stage objects are needed to complete a request from the program instance, the system avoids the computational cost that would otherwise be incurred by eagerly creating new stage objects not subsequently needed to complete a request from the program instance. The system may track the stage objects that have not yet been rebased to the new staging area using colored pointers.

In one or more embodiments, the program thread, acting pursuant to the barrier, may update the cannon objects to match the state of the new stage objects (Operation 616). In other words, the program thread may commit the new version of the target objects to the shared area of runtime memory and/or the program thread's local area of runtime memory. After committing the new version of the target objects, the cannon objects will also correspond to the new version of the target objects. Accordingly, the program thread may also update the version history of the cannon objects to reflect this change, and/or the program thread may update other mechanisms that are used to track the most recent version of the cannon objects. In some embodiments, the program thread may not update the canon objects whenever a new version of the target objects is created in a staging area. In these embodiments, the program thread may periodically or selectively skip this operation. In other embodiments, the program thread may update the canon objects whenever a new version of the target objects is created, and the program thread will generally not skip this operation.

In an embodiment, the program thread acquires a lock on a cannon object that resides in the shared area of runtime memory (i.e., a shared object) before updating this cannon object to match the state of a corresponding new stage object. By acquiring a lock on a shared object, the program thread ensures that no other thread can mutate that shared object while the program thread holds the lock. In this way, the program thread may prevent concurrency issues that could otherwise arise due to another thread concurrently attempting to commit another new version of the target objects.

In an embodiment, the program thread adds the new commit object to an object graph of commit objects that records the version history of the cannon objects. In this way, the program thread updates the version history of the cannon objects. For example, to add the new commit object to this object graph of commit objects, the program thread may store a reference in the new commit object that points to the commit object for the cannon objects. Additionally, or alternatively, the program thread updates other mechanisms used to locate the commit object corresponding to the most recent version of the cannon objects. As an example, assume the cannon objects include a version-controlled object, and further assume that this version-controlled object includes a direct-write field. In this example, the program thread may identify a branch object referenced by the newly staged copy of this direct-write field, and the program thread may remap a reference in this branch object used to track the commit object that corresponds to most recent version of the cannon objects. In particular, the program thread remaps this reference from the commit object for the cannon objects to the new commit object in this example. In another example, a reference held by a global storage mechanism is used to track the commit object corresponding to the most recent version of the cannon objects, and the program thread remaps this reference from the commit object for the cannon objects to the new commit object in this example. In yet another example, there may be multiple mechanisms used to track the commit object that corresponds to the most recent version of the cannon objects.

In one or more embodiments, the program thread performs the program task that is requested by the program instance (Operation 618). As noted above, the executable instructions for completing the program task may instruct the program thread to directly manipulate the cannon objects. Rather than allowing the program thread to directly manipulate the cannon objects, the program thread may be compelled to perform the program task in a staging area. In particular, the program thread may be compelled to perform the program task in the program thread's current staging area and/or the program thread's new staging area. Compelling the program thread to perform the program task in a staging area may prevent a concurrency issue, such an infinite loop, that might otherwise be created if the program task were allowed to manipulate a shared object while another thread is concurrently manipulating the same shared object. Changes to staged objects that occur while the program thread completes the program task may subsequently be committed during another synchronization attempt between the program thread's stage objects and the cannon objects. However, note that if the synchronization trigger was an attempt to write to a direct-write field of a cannon object, this mutation may be made to the cannon object as the program thread is performing the program task.

In one or more embodiments, the program thread, acting pursuant to the barrier, responds to a causality bug associated with conflicting mutations to the target objects (Operation 620). In particular, the program thread responds to a causality bug associated with at least one conflict between the canonized mutations and the staged mutations. Example responses to the causality bug include blocking the program task, blocking other requests by the program instance, terminating the program instance, generating a record of the conflict that revealed the causality bug, identifying a source of the causality bug in the executable instructions of the program instance, alerting a user of the causality bug and/or the source of the causality bug, altering the executable instructions of the program instance to resolve the causality bug, and others.

In an embodiment, the program thread responds to the causality bug by generating a record of undecided locations in memory. For example, if the canonized mutations and the staged mutations both updated the same field of a target object, the program thread may record that field as an undecided location in memory. In this example, this field is “undecided” because it may be unclear which update to this field should take precedence over the other. In this embodiment, the record of undecided locations in memory may be reported to a user, so the user can resolve the underlying issues in the executable instructions of the program instance that resulted in the conflict between the canonized mutations and the staged mutations

### 5. Example Embodiment

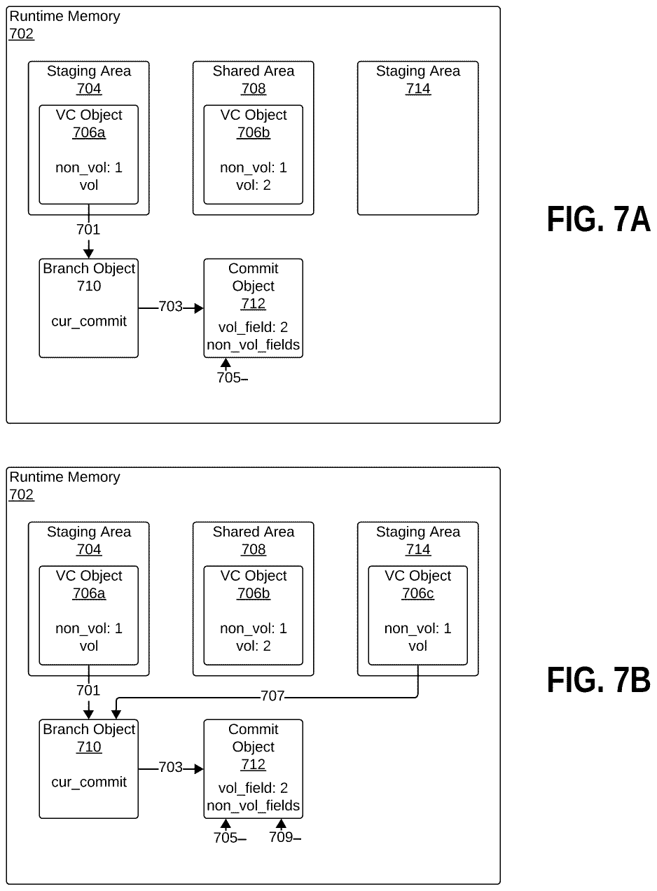

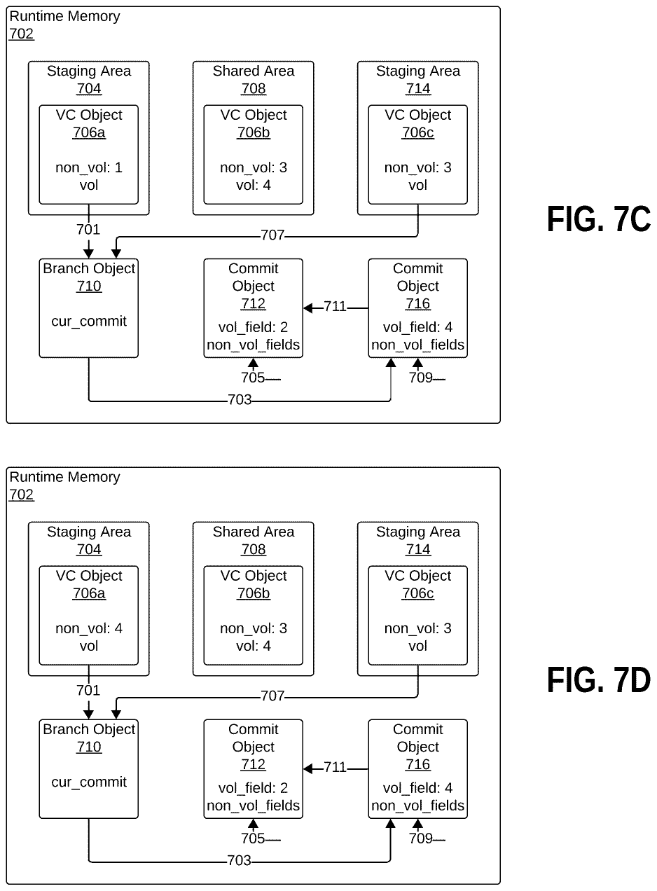

FIGS. 7A, 7B, 7C, and 7D illustrate the impact of an example set of operations for version management in accordance with an example embodiment.

A detailed example is described below for purposes of clarity. Components and/or operations described below should be understood as one specific example that may not be applicable to certain embodiments. Accordingly, components and/or operations described below should not be construed as limiting the scope of any of the claims. For the purposes of this example, consider the class “Example” below that includes the non-volatile field “non_vol” (i.e., a non-direct-write field) and the volatile field “vol” (i.e., a direct-write field), and assume that accesses to volatile fields are synchronization triggers.
class Example {
   public int non_vol;
   public volatile int vol;
}

In an example embodiment, a first program thread creates version-controlled (VC) object 706a in the first program thread's staging area 704 of runtime memory 702 by instantiating the “Example” class and rendering that class instance reachable from another stage copy of a shared object (not depicted in FIG. 7A). VC object 706a is a stage copy of VC object. The first program thread stores the value “1” to “non_vol” in VC object 706a, and the first program thread subsequently attempts to store the value “2” to “vol” in VC object 706a. As “vol” in VC object 706a is a volatile field, a synchronization attempt is triggered. At present, no version of VC object has been published to the shared area 708; therefore, the first program thread can commit VC object 706a to the shared area 708 without risking a conflict. In committing VC object 706a to the shared area 708, the first program thread creates VC object 706b. In VC object 706b, the first program thread stores the value “1” to “non_vol,” and the first program thread stores the value “2” to “vol.” VC object 706b is a shared copy of VC object. By creating VC object 706b, the first program thread establishes a first version of VC object. In addition to creating VC object 706b, the first program thread creates a branch object 710 and a first commit object 712. The first commit object 712 represents the first version of VC object that is established by committing VC object 706a to the shared area 708. In “vol” of VC object 706a, the first program thread stores a pointer 701 to branch object 710. In “cur_commit” of branch object 710, the first program thread stores a pointer 703 to the first commit object 712. In “vol_field” of the first commit object 712, the first program thread stores the value “2” (i.e., the same value held by “vol” of VC object 706b). Note that a subsequent read directed to “vol” in VC object 706a will return the value held by “vol_field” in commit object 712. In “non_vol_fields,” the first program thread stores information describing the non-volatile state of the first version of VC object. For instance, “non_vol_fields” in the first commit object 712 includes the value stored to “non_vol” of VC object (i.e., “1”) and/or information describing other mutations to VC object 706a that occurred prior to the establishment of the first version of VC object. The first program thread stores another pointer 705 to the first commit object 712 in another memory location. For instance, this other pointer 705 may originate from another runtime object within runtime memory 702 accessible to the first program thread, a global variable, a thread-local variable, a local variable, or any another memory location readily accessible to the first program thread. This other pointer 705 will serve as mechanism for tracking the version of the VC object that currently resides in the current staging area of the first program thread. At this time, staging area 704 is the current staging area of the first program thread. The state of runtime memory 702 following the foregoing operations is illustrated by FIG. 7A.

In an example embodiment, a second program thread attempts some program task associated with a synchronization trigger; in the resulting, and successful, synchronization attempt, the second program thread creates VC object 706c in a staging area 714 of runtime memory 702 allocated for the second program thread. VC object 706c is another stage copy of VC object created by copying from VC object 706b. When created, VC object 706b also corresponds to the first version of VC object. In the “vol” field of VC object 706c, the second program thread stores a pointer 707 to branch object 710. The second program thread also stores another pointer 709 to the first commit object 712 in another location in memory. The other pointer 709 to the first commit object 712 will serve as a mechanism for tracking what version of VC object currently resides in the current staging area of the second program thread. At this time, staging area 714 is the current staging area of the second program thread. The state of runtime memory 702 following the foregoing operations is illustrated by FIG. 7B.

In an example embodiment, the second program thread writes the value “3” to “non_vol” of VC object 706c, and the second program thread subsequently attempts to write the value “4” to “vol” of VC object 706c.” In this example, writing to “non_vol” of VC object 706c does not trigger a synchronization attempt because “non_vol” is not a volatile field. However, as “vol” of VC object 706c is a volatile field, a synchronization attempt is triggered by the second program thread's attempt to write to this field. By traversing pointer 707 and pointer 703, the second program thread discerns that the first version of VC object is the version of VC object currently published to the shared area 708. By traversing pointer 709, the second program thread discerns that the first version of VC object is also the version of VC object that the second program thread has been mutating in the staging area 714. As the current version of VC object 706b coincides with the current version of VC object 706c, the second program thread can assume there are no conflicting mutations to these copies of VC object. Accordingly, the second program thread proceeds with committing the mutations to VC object 706c to the shared area 708. In “non_vol” of VC object 706b, the second program thread stores the value “3” (i.e., the value presently stored to “non_vol” in VC object 706c). In “vol” of VC object 706b, the second program thread stores the value “4” (i.e., the value that the second program thread attempted to store to “vol” in VC object 706c). By updating VC object 706b in this manner, the second program thread establishes a second version of VC object. The second program thread creates a second commit object 716 to represent the second version of VC object. In “vol_field” of the second commit object 716, the second program thread stores the value “4” (i.e., the value held by “vol” of VC object 706b). In “non_vol_fields” of the second commit object 716, the second program thread records the mutation to “non_vol” in VC object 706c. The second program thread remaps pointer 703 in branch object 710 to the second commit object 716. To reflect VC object 706c now corresponding to the second version of VC object 706, the second program thread remaps pointer 709 to the second commit object 716. To record a happens-before ordering between versions of VC object 706, the second program thread stores, within the second commit object 716, a pointer 711 to the first commit object 712. The state of runtime memory 702 following the foregoing operations is illustrated by FIG. 7C.

In an example embodiment, the first program thread writes a new value (i.e., “5”) to “non_vol” of VC object 706a, and the first program thread subsequently attempts to read from “vol” of VC object 706a. In this example, writing to “non_vol” of VC object 706a does not trigger a synchronization attempt because “non_vol” is not a volatile field. However, as “vol” of VC object 706a is a volatile field, a synchronization attempt is triggered by the second program thread's attempt to read from this field. By traversing pointer 701 and pointer 703, the first program thread discerns that the second version of shared object is the version of VC object currently published to the shared area 708. By traversing pointer 705, the program thread discerns that the first version of shared object is the current version of VC object that the first program thread has been mutating in the staging area 704. As the version of VC object 706b does not align with the current version of VC object 706a, the first program thread compares the mutations recorded in “non_vol_fields” of the second commit object 716 with the value stored to “non_vol” in VC object 706a. In this way, the first program thread discerns that the mutation to “non_vol” in VC object 706c by the second program thread conflicts with the first program thread's mutation to “non_vol” in VC object 706a. This conflict is the result of a causality bug in the program instance that is being executed by the first program thread and the second program thread. The state of runtime memory 702 following the foregoing operations is illustrated by FIG. 7D. In response to discovering the conflicting mutations to “non_vol,” the program instance may be terminated and/or other corrective actions may be performed.

### 6. Practical Applications and Advantages

One or more embodiments prevent concurrency issues by compelling program threads to indirectly manipulate shared information through copies of the shared information created in isolated sections of runtime memory. For instance, rather than permitting a program thread to directly read from and/or write to a shared object residing in a shared area of runtime memory while completing a program task, the system directs the program thread to create a copy of the shared object (i.e., a stage object) in a staging area of runtime memory allocated for the program thread, and the system directs the program thread to read from and/or write to this stage object while completing the program task. The stage object residing in the program thread's staging area is not exposed to other program threads. Therefore, the program thread is free to manipulate the stage object without risk of another program thread mutating the stage object while the program thread is concurrently attempting to complete the program task in the staging area. In this way, the system eliminates the possibility of a concurrency issue, such as an infinite loop, that could arise if (a) the program thread were to instead perform the program task directly on the shared object and (b) another program thread accessed the shared object while the program thread is concurrently attempting to complete the program task in the shared area. Upon completing the program task, the system may allow the program thread to publish any changes made to the stage object to the shared area by synchronizing the shared object with the stage object.

One or more embodiments track the different versions of a shared data set created by separate program threads executing a program instance and detect causality bugs in the program instance by identifying merge conflicts between the different versions of the shared data set. For instance, the system may allow program threads to create isolated copies of the same set of runtime objects in staging areas of runtime memory that are respectively allocated to the program threads, and the system allows the program threads to create different versions of the set of runtime objects by mutating these isolated copies. At the same time, a shared copy of the set of runtime objects is maintained in a shared area of runtime memory. For any given copy of the set of runtime objects that resides in a staging area or the shared area, the system tracks the version of the set of runtime objects that this given copy corresponds to. By independently tracking the multiple versions of the multiple copies of the set of runtime objects, the system can discern if two separate copies of the set of runtime objects potentially include conflicting mutations. If separate copies of the set of runtimes potentially include conflicting mutations, the system compares mutations that have been applied to these separate copies to determine if there are, in fact, any conflicting mutations. If the system identifies conflicting mutations to separate copies of the set of runtime objects, the system has identified a manifestation of a causality bug in the program instance. Upon identifying a causality bug in the program instance, the system flags this causality bug, so this causality bug can be remedied by a developer of the program instance. Note that conflicting mutations to same memory location do not necessarily create an evident concurrency issue. Accordingly, the concurrency issues spawned by a causality bug may seem to appear infrequently and randomly during program execution. The sporadic appearances of concurrency issues that result from a causality bug can make it difficult and time consuming to diagnose and resolve that causality bug. However, using the techniques described herein, the system may detect manifestations of a causality bug in a program instance where these manifestations do not necessarily result in an evident concurrency issue. As a result, the system may greatly simplify diagnosing a causality bug whose manifestations might go unnoticed except where these manifestations result in an evident concurrency issue.

One or more embodiments track a happens-before ordering of versions of a shared data set and reference this happens-before ordering to detect, prevent, and diagnose potential concurrency issues. For instance, when a program thread creates a new version of a set of runtime objects by synchronizing a shared copy of the set of runtime objects with an isolated copy of the set of runtime objects, the system generates a commit object to represent this new version of the set of runtime objects. Furthermore, the system adds this commit object to an object graph of commit objects. The object graph of commit objects tracks a happens-before ordering of versions of the set of runtime objects. In particular, the happens-before ordering of the versions is tracked by references that interconnect the commit objects within the object graph. The references between commit objects may reflect both sequential and causal relationships between the versions of the set of runtime objects. Furthermore, any given commit object representing a given version of the set of runtime objects may record the mutations that were applied to the set of runtime objects that derived the given version from a prior version of the set of runtime objects. By ordering the mutations to the set of runtime objects as version changes in a happens-before ordering, the system eliminates complexities in diagnosing concurrency issues that result from differences between the implicit memory ordering of different underlying hardware platforms supporting a computing environment, including threads and the runtime memory. As a result, any merge conflicts that occur when a program thread synchronizes the program thread's isolated copy of the set of runtime objects with the shared copy of the set of runtimes objects can be easily traced back to the shortcomings in a developer's source code that are causing the merge conflicts based on the object graph.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

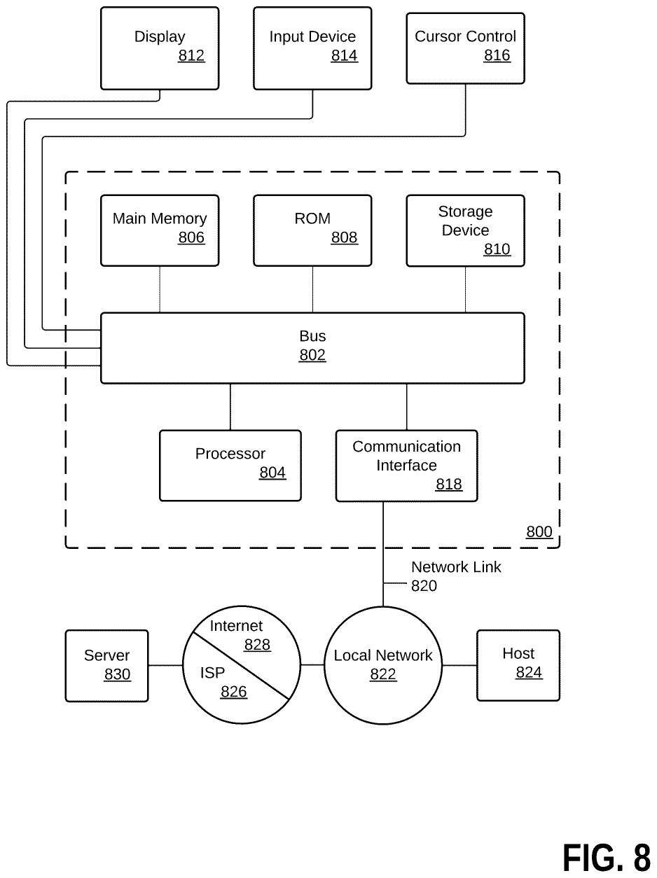

For example, FIG. 8 is a block diagram that illustrates a computer system 800 upon which an embodiment of this disclosure may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions included in main memory 806. Such instructions may be read into main memory 806 from another storage medium, such as storage device 810. Execution of the sequences of instructions included in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infrared data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
responsive to a first thread attempting to access a direct-write field in a target object of one or more objects:
determining that a first copy of the one or more objects corresponds to a first version of the one or more objects, the first copy of the one or more objects comprised within a first section of runtime memory that is (a) exposed to the first thread and (b) not exposed to a second thread, wherein the first copy of the one or more objects comprises a first copy of the target object;
determining that a second copy of the one or more objects corresponds to a second version of the one or more objects, the second copy of the one or more objects residing in a shared area of the runtime memory that is exposed to a plurality of threads comprising the first thread and the second thread, wherein determining that the second copy of the one or more objects corresponds to the second version of the one or more objects comprises traversing one or more pointers linking (a) the direct-write field in the first copy of the target object to (b) a second object that represents the second version of the one or more objects;
based on comparing the first version of the one or more objects to the second version of the one or more objects, determining that the first version is not the second version;
responsive to determining that the first version is not the second version:
identifying a first mutation that the first thread applied to the first copy of the one or more objects;
identifying a second mutation that the second thread committed to the second copy of the one or more objects; and
determining that the first mutation conflicts with the second mutation.

2. The one or more non-transitory computer-readable media of claim 1, wherein the operations further comprise:
prior to identifying the first mutation and the second mutation, identifying an ancestor version of the one or more objects that (a) the first copy of the one or more objects is derived from and (b) the second copy of the one or more objects is derived from,
wherein (a) identifying the first mutation is based on identifying a first set of one or more mutations that derived the first copy of the one or more objects from the ancestor version of the one or more objects and (b) identifying the second mutation is based on identifying a second set of one or more mutations that derived the second copy of the one or more objects from the ancestor version of the one or more objects.

3. The one or more non-transitory computer-readable media of claim 2:
wherein determining that the first copy of the one or more objects corresponds to the first version of the one or more objects comprises traversing a pointer to a first object that represents the first version of the one or more objects;
wherein identifying the first set of one or more mutations comprises traversing a first set of one or more pointers linking (a) the first object that represents the first version of the one or more objects to (b) a third object that represents the ancestor version of the one or more objects; and
wherein identifying the second set of one or more mutations comprises traversing a second set of one or more pointers linking (a) the second object that represents the second version of the one or more objects to (b) the third object that represents the ancestor version of the one or more objects.

4. The one or more non-transitory computer-readable media of claim 1:
wherein the first copy of the one or more objects comprises a first copy of a particular object, the particular object comprising a particular field;
wherein the second copy of the one or more objects comprises a second copy of the particular object; and
wherein determining that the first mutation conflicts with the second mutation comprises:
determining that the first mutation updates the particular field in the first copy of the particular object; and
determining that the second mutation updates the particular field in the second copy of the particular object.

5. The one or more non-transitory computer-readable media of claim 4, wherein the operations further comprise:
responsive to determining that the first mutation conflicts with the second mutation, generating a list of one or more fields in the one or more objects that are associated with conflict between (a) a first set of one or more mutations applied to the first copy of the one or more objects and (b) a second set of one or more mutations committed to the second copy of the one or more objects, wherein the list of one or more fields comprises the particular field; and
presenting, to a user, the one or more fields as a set of one or more undecided memory locations associated with a causality bug in a program instance that is being executed by the plurality of threads.

6. The one or more non-transitory computer-readable media of claim 1, wherein the operations further comprise:
prior to the first thread attempting to access the direct-write field:
creating the first version of the one or more objects, wherein creating the first version of the one or more objects comprises:
generating the first copy of the one or more objects in the first section of the runtime memory;
generating a first object that represents the first version of the one or more objects; and
generating the one or more pointers to link (a) the direct-write field in the first copy of the target object to (b) the first object that represents the first version of the one or more objects;
creating the second version of the one or more objects, wherein creating the second version of the one or more objects comprises:
generating the second copy of the one or more objects in the shared area of the runtime memory;
generating the second object that represents the second version of the one or more objects; and
remapping the one or more pointers to link (a) the direct-write field in the first copy of the target object to (b) the second object that represents the second version of the one or more objects.

7. The one or more non-transitory computer-readable media of claim 6, wherein generating the second copy of the one or more objects comprises:
mutating, by the second thread, a third copy of the one or more objects that is comprised within a second section of the runtime memory that is (a) not exposed to the first thread and (b) exposed to the second thread; and
synchronizing (a) a shared state of the second copy of the one or more objects with (b) a mutated state of the third copy of the one or more objects.

8. The one or more non-transitory computer-readable media of claim 1:
wherein a barrier is imposed on the first thread in response to the first thread attempting to access the direct-write field in the target object;
wherein the first thread determines that the first version is not the second version while executing the barrier; and
wherein the first thread determines that the first mutation conflicts with the second mutation while executing the barrier.

9. A method comprising:
responsive to a first thread attempting to access a direct-write field in a target object of one or more objects:
determining that a first copy of the one or more objects corresponds to a first version of the one or more objects, the first copy of the one or more objects comprised within a first section of runtime memory that is (a) exposed to the first thread and (b) not exposed to a second thread, wherein the first copy of the one or more objects comprises a first copy of the target object;
determining that a second copy of the one or more objects corresponds to a second version of the one or more objects, the second copy of the one or more objects residing in a shared area of the runtime memory that is exposed to a plurality of threads comprising the first thread and the second thread, wherein determining that the second copy of the one or more objects corresponds to the second version of the one or more objects comprises traversing one or more pointers linking (a) the direct-write field in the first copy of the target object to (b) a second object that represents the second version of the one or more objects;
based on comparing the first version of the one or more objects to the second version of the one or more objects, determining that the first version is not the second version;
responsive to determining that the first version is not the second version:
identifying a first mutation that the first thread applied to the first copy of the one or more objects;
identifying a second mutation that the second thread committed to the second copy of the one or more objects; and
determining that the first mutation conflicts with the second mutation,
wherein the method is performed by at least one device including a hardware processor.

10. The method of claim 9, further comprising:
prior to identifying the first mutation and the second mutation, identifying an ancestor version of the one or more objects that (a) the first copy of the one or more objects is derived from and (b) the second copy of the one or more objects is derived from,
wherein (a) identifying the first mutation is based on identifying a first set of one or more mutations that derived the first copy of the one or more objects from the ancestor version of the one or more objects and (b) identifying the second mutation is based on identifying a second set of one or more mutations that derived the second copy of the one or more objects from the ancestor version of the one or more objects.

11. The method of claim 10:
wherein determining that the first copy of the one or more objects corresponds to the first version of the one or more objects comprises traversing a pointer to a first object that represents the first version of the one or more objects;
wherein identifying the first set of one or more mutations comprises traversing a first set of one or more pointers linking (a) the first object that represents the first version of the one or more objects to (b) a third object that represents the ancestor version of the one or more objects; and
wherein identifying the second set of one or more mutations comprises traversing a second set of one or more pointers linking (a) the second object that represents the second
version of the one or more objects to (b) the third object that represents the ancestor version of the one or more objects.

12. The method of claim 9:
wherein the first copy of the one or more objects comprises a first copy of a particular object, the particular object comprising a particular field;
wherein the second copy of the one or more objects comprises a second copy of the particular object; and
wherein determining that the first mutation conflicts with the second mutation comprises:
determining that the first mutation updates the particular field in the first copy of the particular object; and
determining that the second mutation updates the particular field in the second copy of the particular object.

13. The method of claim 12, further comprising:
responsive to determining that the first mutation conflicts with the second mutation, generating a list of one or more fields in the one or more objects that are associated with conflict between (a) a first set of one or more mutations applied to the first copy of the one or more objects and (b) a second set of one or more mutations committed to the second copy of the one or more objects, wherein the list of one or more fields comprises the particular field; and
presenting, to a user, the one or more fields as a set of one or more undecided memory locations associated with a causality bug in a program instance that is being executed by the plurality of threads.

14. The method of claim 9, further comprising:
prior to the first thread attempting to access the direct-write field:
creating the first version of the one or more objects, wherein creating the first version of the one or more objects comprises:
generating the first copy of the one or more objects in the first section of the runtime memory;
generating a first object that represents the first version of the one or more objects; and
generating the one or more pointers to link (a) the direct-write field in the first copy of the target object to (b) the first object that represents the first version of the one or more objects;
creating the second version of the one or more objects, wherein creating the second version of the one or more objects comprises:
generating the second copy of the one or more objects in the shared area of the runtime memory;
generating the second object that represents the second version of the one or more objects; and
remapping the one or more pointers to link (a) the direct-write field in the first copy of the target object to (b) the second object that represents the second version of the one or more objects.

15. The method of claim 14, wherein generating the second copy of the one or more objects comprises:
mutating, by the second thread, a third copy of the one or more objects that is comprised within a second section of the runtime memory that is (a) not exposed to the first thread and (b) exposed to the second thread; and
synchronizing (a) a shared state of the second copy of the one or more objects with (b) a
mutated state of the third copy of the one or more objects.

16. The method of claim 9:
wherein a barrier is imposed on the first thread in response to the first thread attempting to access the direct-write field in the target object;
wherein the first thread determines that the first version is not the second version while executing the barrier; and
wherein the first thread determines that the first mutation conflicts with the second mutation while executing the barrier.

17. A system comprising:
one or more hardware processors;
one or more non-transitory computer-readable media; and
program instructions stored on the one or more non-transitory computer-readable media which, when executed by the one or more hardware processors, cause the system to perform operations comprising:
responsive to a first thread attempting to access a direct-write field in a target object of one or more objects:
determining that a first copy of the one or more objects corresponds to a first version of the one or more objects, the first copy of the one or more objects comprised within a first section of runtime memory that is (a) exposed to the first thread and (b) not exposed to a second thread, wherein the first copy of the one or more objects comprises a first copy of the target object;
determining that a second copy of the one or more objects corresponds to a second version of the one or more objects, the second copy of the one or more objects residing in a shared area of the runtime memory that is exposed to a plurality of threads comprising the first thread and the second thread, wherein determining that the second copy of the one or more objects corresponds to the second version of the one or more objects comprises traversing one or more pointers linking (a) the direct-write field in the first copy of the target object to (b) a second object that represents the second version of the one or more objects;
based on comparing the first version of the one or more objects to the second version of the one or more objects, determining that the first version is not the second version;
responsive to determining that the first version is not the second version:
identifying a first mutation that the first thread applied to the first copy of the one or more objects;
identifying a second mutation that the second thread committed to the second copy of the one or more objects; and
determining that the first mutation conflicts with the second mutation.

18. The system of claim 17, wherein the operations further comprise:
prior to identifying the first mutation and the second mutation, identifying an ancestor version of the one or more objects that (a) the first copy of the one or more objects is derived from and (b) the second copy of the one or more objects is derived from,
wherein (a) identifying the first mutation is based on identifying a first set of one or more mutations that derived the first copy of the one or more objects from the ancestor version of the one or more objects and (b) identifying the second mutation is based on identifying a second set of one or more mutations that derived the second copy of the one or more objects from the ancestor version of the one or more objects.

19. The system of claim 18:
wherein determining that the first copy of the one or more objects corresponds to the first version of the one or more objects comprises traversing a pointer to a first object that represents the first version of the one or more objects;
wherein identifying the first set of one or more mutations comprises traversing a first set of one or more pointers linking (a) the first object that represents the first version of the one or more objects to (b) a third object that represents the ancestor version of the one or more objects; and
wherein identifying the second set of one or more mutations comprises traversing a second set of one or more pointers linking (a) the second object that represents the second version of the one or more objects to (b) the third object that represents the ancestor version of the one or more objects.

20. The system of claim 17:
wherein the first copy of the one or more objects comprises a first copy of a particular object, the particular object comprising a particular field;
wherein the second copy of the one or more objects comprises a second copy of the particular object; and
wherein determining that the first mutation conflicts with the second mutation comprises:
determining that the first mutation updates the particular field in the first copy of the particular object; and
determining that the second mutation updates the particular field in the second copy of the particular object.
